(19) United States
(12) Patent Application Publication
(10) Pub. No.: US 2020/0267674 A1
(43) Pub. Date: Aug. 20, 2020

(54) METHOD AND APPARATUS FOR TRANSMITTING AND RECEIVING SYNCHRONIZATION SIGNAL IN WIRELESS COMMUNICATION SYSTEM

(71) Applicant: Samsung Electronics Co., Ltd., Gyeonggi-do (KR)

(72) Inventors: Hyoungju Ji, Gyeonggi-do (KR); Hoondong Noh, Gyeonggi-do (KR); Heecheol Yang, Gyeonggi-do (KR); Younsun Kim, Gyeonggi-do (KR); Taehyoung Kim, Gyeonggi-do (KR); Juho Lee, Gyeonggi-do (KR)

(21) Appl. No.: 16/795,005

(22) Filed: Feb. 19, 2020

(30) Foreign Application Priority Data
Feb. 19, 2019 (KR) 10-2019-0019193

(51) Int. Cl. H04W 56/00; H04L 5/00

(52) U.S. Cl. CPC H04W 56/001; H04L 5/0048

(57) ABSTRACT

A method, of a user equipment, of transmitting and receiving a synchronization signal in a wireless communication system is provided. The method includes receiving a synchronization signal block (SSB) from a base station; recovering synchronization signals from the SSB, based on at least one waveform candidates for the SSB; and obtaining system information based on the recovered synchronization signals.

### CROSS-REFERENCE TO RELATED APPLICATION

This application is based on and claims priority under 35 U.S.C. § 119 to Korean Patent Application No. 10-2019-0019193, file on Feb. 19, 2019, in the Korean Intellectual Property Office, the disclosure of which is incorporated by reference herein in its entirety.

### BACKGROUND

### 1. Field

The disclosure relates to a method and apparatus for communication between a base station (BS) and a user equipment (UE), and more particularly, to a method and apparatus for transmitting, by a BS, a synchronization signal and a channel in a downlink by using a single carrier in a millimeter-wave wireless communication system.

### 2. Description of Related Art

To meet the soaring demand with respect to wireless data traffic due to the commercialization of 4^{th}-generation (4G) communication systems, efforts have been made to develop improved 5^{th}-generation (5G) communication systems or pre-5G communication systems. For this reason, the 5G communication system or the pre-5G communication system is also called a beyond-4G-network communication system or a post-long term evolution (LTE) system. For higher data transmission rates, the implementation of 5G communication systems on ultra-high frequency bands (e.g., millimeter wave (mmWave)), e.g., 60 GHz, is being considered. In 5G communication systems, beamforming, massive multi-input multi-output (MIMO), full dimensional MIMO (FD-MIMO), array antenna, analog beamforming, and large-scale antenna technologies have been discussed as ways of alleviating propagation path loss and increasing propagation distances in ultra-high frequency bands. In order to improve system networks, in 5G communication systems, various technologies have been developed, such as evolved or advanced small cell, cloud radio access network (cloud RAN), ultra-dense network, device-to-device (D2D) communication, wireless backhaul, moving network, cooperative communication, coordinated multi-point (CoMP), and interference cancellation. In addition, for 5G systems, other technologies have been developed, such as hybrid frequency-shift keying (FSK) and quadrature amplitude modulation (QAM) modulation (FQAM) and sliding window superposition coding (SWSC), which are advanced coding modulation (ACM) schemes, and filter bank multi carrier (FBMC), non-orthogonal multiple access (NOMA), and sparse code multiple access (SCMA), which are advanced access schemes.

The Internet is now evolving into the Internet of things (IoT), where distributed entities, such as objects, exchange and process information. The Internet of everything (IoE) has also emerged, which is a combination of IoT technology and big data processing technology through connection with a cloud server, etc. In order to implement IoT, technological elements, such as sensing technology, wired/wireless communication and network infrastructure, service interface technology, and security technology, are required, and, in this regard, technologies such as sensor networks, machine to machine (M2M), machine-type communication (MTC), and so forth have recently been researched for connection between things. Such an IoT environment may provide intelligent Internet technology (IT) services that create new value to human life by collecting and analyzing data generated among connected things. IoT may be applied to a variety of fields including smart homes, smart buildings, smart cities, smart cars or connected cars, smart grids, health care, smart appliances, advanced medical services, and so forth through convergence and combination between existing information technology and various industries.

Thus, various attempts have been made to apply 5G communication systems to IoT networks. For example, 5G communication, such as sensor networks, M2M, MTC, etc., has been implemented by a scheme such as beamforming, MIMO, an array antenna, and so forth. The application of cloud RAN as a big data processing technology may also be an example of the convergence of 5G technology and IoT technology.

In general, a mobile communication system has been developed to offer communication services to users while ensuring mobility of the users. Thanks to rapid technical advancement, mobile communication systems are capable of providing not only voice communication services but also high-speed data communication services. Recently, standardization for a new radio (NR) system, one of the next-generation mobile communication systems, is underway in the 3^{rd} Generation Partnership Project (3GPP). The NR system has been developed to satisfy various network requirements and achieve a wide range of performance goals, and in particular, is a technology that implements millimeter-wave-band communication. The NR system may be understood to include a 5G NR system, a 4G LTE system, and an LTE-advanced (LTE-A) system that support microwaves as well as communication in a millimeter-wave band over 6 GHz.

In a mmWave band over 6 GHz, signal transmission using high power is required to compensate for a high path loss between a BS and a UE and a power loss and signal attenuation resulting from a low-efficiency amplifier. In this case, a multi-carrier transmission technique is difficult to use.

### SUMMARY

An aspect of the disclosure provides a method and apparatus for effectively transmitting and receiving a synchronization signal and a channel by using a single carrier in a mmWave band.

According to an aspect of the disclosure, a method, of a user equipment, of transmitting and receiving a synchronization signal in a wireless communication system is provided. The method includes receiving a synchronization signal block (SSB) from a base station; recovering synchronization signals from the SSB, based on at least one waveform candidates for the SSB; and obtaining system information based on the recovered synchronization signals.

According to another aspect of the disclosure, a method, by a base station, of transmitting and receiving a synchronization signal in a wireless communication system is provided. The method includes determining at least one waveform candidates for an SSB; and transmitting the SSB based on the determined at least one waveform candidates, wherein system information is obtained by a user equipment based on synchronization signals recovered from the SSB.

According to another aspect of the disclosure, a user equipment for transmitting and receiving a synchronization signal in a wireless communication system is provided. The user equipment includes a transceiver; and at least one processor coupled with the transceiver and configured to control the transceiver to receive an SSB from a BS, recover synchronization signals from the SSB, based on at least one waveform candidates for the SSB, and obtain system information based on the recovered synchronization signals.

According to another aspect of the disclosure, a base station for transmitting and receiving a synchronization signal in a wireless communication system is provided. The base station includes a transceiver; and at least one processor coupled with the transceiver and configured to determine at least one waveform candidates for an SSB, and control the transceiver to transmit the SSB based on the determined at least one waveform candidates, wherein system information is obtained by a user equipment based on synchronization signals recovered from the SSB.

### BRIEF DESCRIPTION OF THE DRAWINGS

The above and other aspects, features, and advantages of certain embodiments of the present disclosure will be more apparent from the following description, taken in conjunction with the accompanying drawings, in which:

FIG. 1A is an illustration of a structure of a time-frequency domain that is a NR system resource area, according to an embodiment;

FIG. 1B is an illustration of a slot structure in an NR system, according to an embodiment;

FIG. 1C is a block diagram of a communication system in which data is transmitted and received between a BS and a UE, according to an embodiment;

FIG. 2 is an illustration of a method of transmitting a downlink synchronization signal (SS) and a physical broadcast channel (PBCH);

FIG. 3 is an illustration of a method of transmitting an SSB in mmWaves, according to an embodiment;

FIG. 4A is an illustration of a resource allocation method for reducing symbol interference, according to an embodiment;

FIG. 4B is an illustration of a method of configuring a single carrier band to reduce symbol interference, according to an embodiment;

FIG. 4C is an illustration of a method of configuring a single carrier band to reduce symbol interference, according to an embodiment;

FIG. 5A is an illustration of a resource allocation method for SS and PBCH transmission, according to an embodiment;

FIG. 5B is an illustration of a resource allocation method for SS and PBCH transmission, according to an embodiment;

FIG. 5C is an illustration of a resource allocation method for SS and PBCH transmission, according to an embodiment;

FIG. 6A is an illustration of a method of determining a bandwidth and a central frequency for SS and PBCH transmission, according to an embodiment;

FIG. 6B is an illustration of a method of determining a bandwidth and a central frequency for SS and PBCH transmission, according to an embodiment;

FIG. 7A is an illustration of a method of multiplexing a reference signal (RS) for PBCH, according to an embodiment;

FIG. 7B is an illustration of a method of multiplexing an RS for PBCH, according to an embodiment;

FIG. 7C is an illustration of a method of multiplexing an RS for PBCH, according to an embodiment;

FIG. 7D is an illustration of a method of multiplexing an RS for PBCH, according to an embodiment;

FIG. 8 is an illustration of a method of configuring SS and PBCH transmission symbols, according to an embodiment;

FIG. 9 is an illustration of a method of transmitting an SS and a PBCH using a first waveform and a second waveform, according to an embodiment;

FIG. 10A is a flowchart of operations of a BS, according to an embodiment;

FIG. 10B is a flowchart of operations of a BS, according to an embodiment;

FIG. 10C is a flowchart of operations of a BS, according to an embodiment;

FIG. 10D is a flowchart of operations of a BS, according to an embodiment;

FIG. 11A is a flowchart of operations of a UE, according to an embodiment;

FIG. 11B is a flowchart of operations of a UE, according to an embodiment;

FIG. 11C is a flowchart of operations of a UE, according to an embodiment;

FIG. 11D is a flowchart of operations of a UE, according to an embodiment;

FIG. 12 is a block diagram of a BS, according to an embodiment; and

FIG. 13 is a block diagram of a UE, according to an embodiment.

### DETAILED DESCRIPTION

Throughout the disclosure, the expression “at least one of a, b or c” indicates only a, only b, only c, both a and b, both a and c, both b and c, all of a, b, and c, or variations thereof.

A terminal may include a UE, a mobile station (MS), a cellular phone, a smartphone, a computer, or a multimedia system capable of performing communication functions.

In the present disclosure, a controller may be referred to as a processor.

In the present disclosure, a layer (e.g., a layer device) may be referred to as an entity.

Hereinafter, embodiments of the disclosure are described in detail with reference to the accompanying drawings.

In the embodiments of the present disclosure described, technical matters that are well known in a technical field of the present disclosure which are not directly related to the present disclosure are omitted. In this way, by omitting any unnecessary description, the subject matter of the present disclosure is more clearly described without being obscured.

For the same reason, some elements will be exaggerated, omitted, or simplified in the accompanying drawings. The size of each element does not entirely reflect the actual size of the element. In each drawing, an identical or corresponding element is identified with an identical reference numeral.

Advantages and features of the technical spirit of the present disclosure and a method for achieving them will be apparent with reference to embodiments of the present disclosure described below together with the accompanying drawings. However, the present disclosure is not intended to be limited to the disclosed embodiments of the disclosure, but may be implemented in various manners, and the embodiments of the disclosure are provided to complete the disclosure and to allow those of ordinary skill in the art to understand the scope of the present disclosure. The present disclosure is defined by the appended claims and their equivalents. Throughout the disclosure, an identical reference numeral indicates an identical element.

It will be understood that each block of a flowchart and/or a block diagram, and combinations of blocks in a flowchart and/or a block diagram, may be implemented by computer program instructions. These computer program instructions may also be stored in a general-purpose computer, a special-purpose computer, or a processor of other programmable data processing devices, such that the instructions implemented by the computer or the processor of the programmable data processing device produce a means for performing functions specified in the flowchart and/or the block diagram block or blocks. These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks. The computer program instructions may also be loaded onto a computer or other programmable data processing apparatus to cause a series of operational steps to be performed on the computer or other programmable apparatus to produce a computer implemented process, such that the instructions that execute the computer or other programmable apparatus may provide steps for implementing the functions specified in the flowchart and/or block diagram block or blocks.

In addition, each block represents a module, segment, or portion of code, which includes one or more executable instructions for implementing the specified logical function(s). In other implementations, the function(s) noted in the blocks may occur out of the order indicated. For example, two blocks shown in succession may, in fact, be executed substantially concurrently or the blocks may sometimes be executed in the reverse order, depending on the functionality involved.

The term “unit” used herein refers to software or a hardware element such as a field-programmable gate array (FPGA), an application specific integrated circuit (ASIC), etc., and “-unit” plays specific roles. However, the meaning of “-unit” is not intended to be limited to software or hardware. “unit” may advantageously be configured to reside on an addressable storage medium and configured to reproduce one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and “-unit(s)” may be combined into fewer components and “unit(s)” or further separated into additional components and “unit(s)”. In addition, components and “-unit(s)” may be implemented to execute one or more central processing units (CPUs) in a device or a secure multimedia card. In the embodiments of the disclosure, ‘unit’ may include one or more processors.

An embodiment of the disclosure is intended for a communication system that transmits a downlink signal from a BS of an NR system to a UE. The downlink signal of the NR may include a data channel in which data information is transmitted, a control channel in which control information is transmitted, and an RS for channel measurement and channel feedback.

More specifically, an NR BS may transmit data and control information to a UE through a physical downlink shared channel (PDSCH) and a physical downlink control channel (PDCCH). The NR BS may have a plurality of RSs that may include one or more of a channel state information (CSI)-RS, a modulation RS, or a demodulation RS (DMRS). The NR BS may transmit a DMRS dedicated for the UE to an area scheduled for data transmission, and transmit a CSI-RS in time-frequency resources to obtain channel information for data transmission. Hereinbelow, transmission/reception of a data channel may be understood as data transmission/reception on the data channel, and transmission/reception of a control channel may be understood as control information transmission/reception on the control channel.

Communication between a BS and a UE in a wireless communication system is closely affected by a propagation environment. In particular, in a 60 GHz band, a signal is difficult to deliver due to high signal attenuation caused by moisture or oxygen over the air and a little scattering effect caused by a short wavelength. Thus, a BS may secure a coverage only when the BS transmits a signal with higher power, and when the BS transmits the signal with high transmission power, a multi-carrier transmission technique showing excellent performance in overcoming a multi-path delay effect in a 4G system may be difficult to use due to a high peak-to-average power ratio (PAPR). However, when single carrier transmission is performed for use of higher transmission power, user multiplexing is difficult to achieve and channel estimation and channel estimation performance of a multi-path signal may degrade. Moreover, to overcome high path loss in mmWaves, analog beams (or beams), e.g., signals having directivity) may be used, in which a bandwidth of the analog beams may be reduced because the wavelength of the mmWaves is very short. When the bandwidth of the analog beams is reduced, it may be more difficult to support multiple users. For the foregoing reasons, system performance in the mmWave band is difficult to guarantee at the same technical level as used in a microwave band.

Therefore, the present disclosure discloses a method and an apparatus for effectively receiving a synchronization signal transmitted from a BS by using a single carrier in an mmWave wave band. In particular, the method and the apparatus according to an embodiment relate to a scenario managed by the BS in the mmWave band.

An NR system has been developed to satisfy various network requirements, and a type of a supportable service in the NR system may be categorized into enhanced mobile broadband (eMBB), massive machine type communications (mMTC), ultra-reliable and low-latency communications (URLLC), etc. The eMBB is a service aimed at high-speed transmission of high-volume data, the mMTC is a service aimed at minimization of power of a UE and accesses by multiple UEs, and the URLLC is a service aimed at high reliability and low latency. Depending on a type of service applied to a UE, different requirements may be applied.

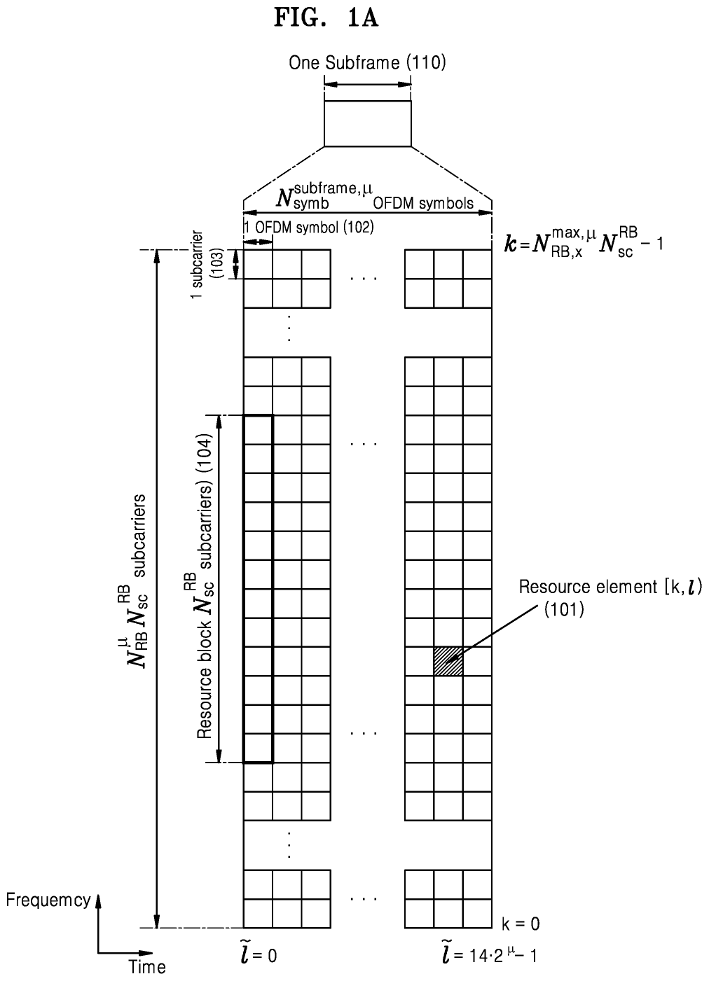

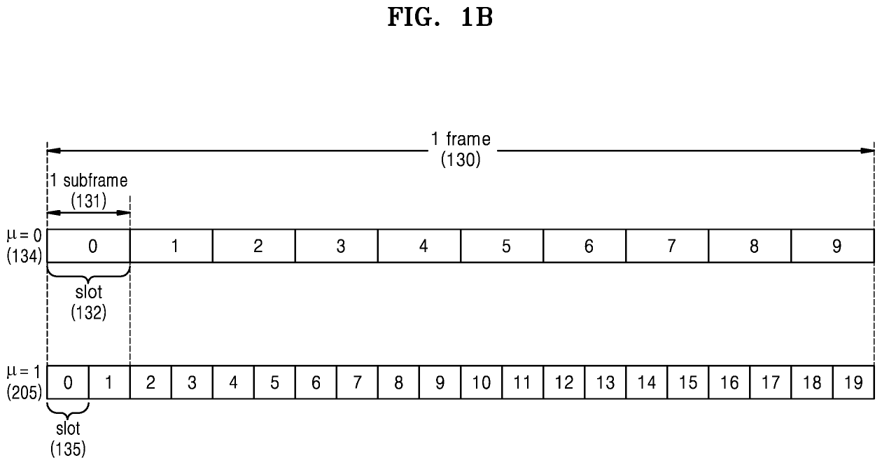

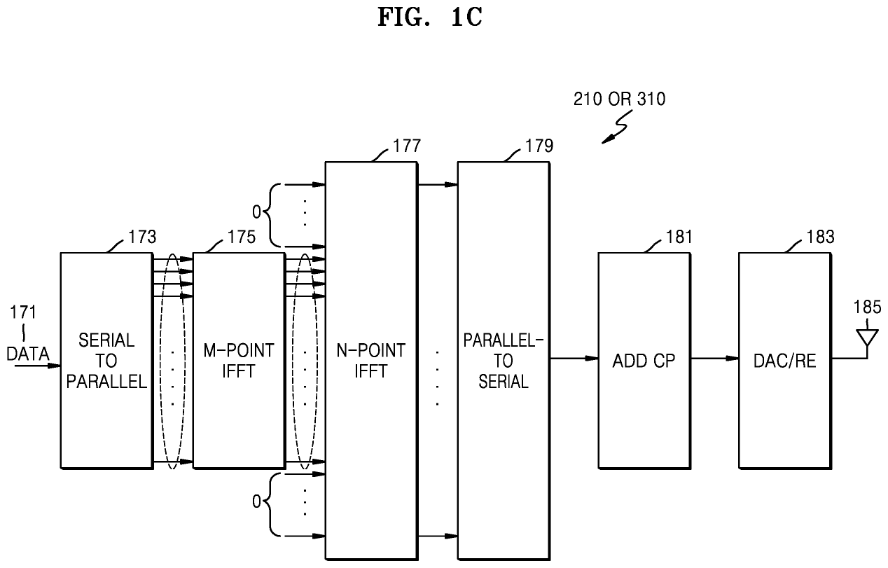

FIG. 1A is an illustration of a structure of a time-frequency domain that is an NR system resource area, according to an embodiment.

Referring to FIG. 1A, a horizontal axis represents a time domain, and a vertical axis represents a frequency domain. In the time and frequency domains, a basic unit of a resource is a resource element (RE) 101 which may be defined as one orthogonal frequency division multiplexing (OFDM) symbol 102 along a time axis and one subcarrier 103 along a frequency axis. In the frequency domain, N_{sc}^{RB} (e.g., 12) consecutive REs may constitute one resource block (RB) (or a physical resource block (PRB)) 104.

FIG. 1B is an illustration of a slot structure in an NR system, according to an embodiment.

Referring to FIG. 1B, a structure of a frame 130, a subframe 131, and a slot 132 is illustrated. One frame 130 may be defined as 10 ms. One subframe 131 may be defined as 1 ms, such that one frame 130 may include a total of ten subframes 131. One slot 132 or 133 may be defined as fourteen OFDM symbols (i.e., the number of symbols per slot (N_{symb}^{slot})=14). One subframe 131 may include one slot or a plurality of slots 132 and 133, and the number of slots 132 and 133 per subframe 131 may vary with set values μ 134 and 135 for a subcarrier interval. An example of FIG. 1B shows μ=0 134 and μ=1 135 as the set values 134 and 135 for the subcarrier interval. For μ=0 134, one subframe 131 may include one slot 132, and for μ=1 135, one subframe 131 may include two of slot 133.

That is, the number of slots per subframe, Nₛₗₒₜ^{subframe,μ}, may differ with the set value p for the subcarrier interval, and the number of slots per frame, Nₛₗₒₜ^{frame,μ}, may vary with the number of slots per subframe. Nₛₗₒₜ^{subframe,μ} and Nₛₗₒₜ^{frame,μ} based on the set value p for the subcarrier interval may be defined as shown in Table 1 below.

TABLE 1

| | Subcarrier | | | |
|---|---|---|---|---|
| μ | Interval (kHz) | N_{symb}^{slot} | Nₛₗₒₜ^{frame, μ} | Nₛₗₒₜ^{subframe, μ} |
| 0 | 15 | 14 | 10 | 1 |
| 1 | 30 | 14 | 20 | 2 |
| 2 | 60 | 14 | 40 | 4 |
| 3 | 120 | 14 | 80 | 8 |
| 4 | 240 | 14 | 160 | 16 |
| 5 | 480 | 14 | 320 | 32 |
| 6 | 960 | 14 | 640 | 64 |

FIG. 1C is a block diagram of a communication system 210 or 310 (or transmitter) in which data is transmitted and received between a BS and a UE, according to an embodiment.

Referring to FIG. 1C, the transmitter 210 or 310 is a system capable of performing OFDM transmission, and may transmit a single carrier (SC) in a bandwidth in which OFDM transmission is possible. The transmitter 210 or 310 may include a serial-to-parallel (SP) converter 173, a single carrier (SC) precoder 175 (or M-point inverse fast Fourier transform (IFFT), an N-point IFFT unit 177, a parallel-to-serial (PS) converter 179, a cyclic prefix (CP) inserter 181, an analog signal unit (including a digital-to-analog converter (DAC)/radio frequency (RF)) 183, and an antenna module 185.

Data 171 having a size of M, having passed through channel coding and modulation (a data sequence having a vector magnitude of M) may be converted into a parallel signal by the SP converter 173, and then may be converted into an SC waveform (SCW) through the SC precoder 175. The SC precoder 175 that converts the parallel signal into the SCW may be implemented using various methods, for example, using a discrete Fourier transform (DFT) preprocessor, up-conversion, or code-spreading. The present disclosure may include various pre-processing methods, and for understanding of a description, the description is made based on an SCW generation method using a DFT preprocessor in the present disclosure, but the present disclosure may also be equally applied to SCW generation using other methods.

A DFT size is equal to M, and a data signal passing through a DFT preprocessor (or a DFT filter) having a length of M may be converted into a broadband frequency signal through the N-point IFFT unit 177. The N-point IFFT unit 177 may perform processing to transmit the parallel signal through each of N subcarriers into which a channel bandwidth is divided. However, DFT preprocessing having a length of M is performed before N-point IFFT processing in FIG. 1C, such that a signal undergoing DFT preprocessing may be transmitted on a single carrier with respect to a central frequency of the bandwidth to which the signal undergoing DFT preprocessing having a length of M is mapped. The N-point IFFT-processed signal (data) may be stored as N samples after passing through the PS converter 179, and some rear samples among the N stored samples may be copied and concatenated to the front. This process may be performed in the CP inserter 181.

Thereafter, the signal may be delivered to the analog signal unit 183 through a pulse shaping filter like a raised cosine filter. The signal delivered to the analog signal unit 183 may be converted into an analog signal through digital-to-analog conversion such as a power amplifier (PA), and the converted analog signal may be delivered to the antenna module 185 and radiated over the air.

A general SCW signal may be transmitted according to a scheme in which M preprocessed signals are mapped to M consecutive subcarriers for transmission, and this process may be performed by the N-point IFFT unit 177. Thus, a magnitude of M may be determined by the size of data to be transmitted or the amount of time symbols used by the data to be transmitted. The magnitude of M is much less than N, because the SCW is a signal of a low PAPR.

The PAPR may indicate a magnitude of a change in a transmission power of a sample of a signal to be transmitted. A high PAPR may indicate a large dynamic range of the PA of the transmitter 210 or 310, which may indicate a large power margin required for operating the PA. For a large power margin required for operating the PA, the transmitter may set a margin of the available PA high against a possibility of a high change. Thus, as a maximum power available to the transmitter decreases, a possible maximum communication distance between the transmitter and a receiver may decrease. On the other hand, for a SCW having a low PAPR, a PA change is very small, such that a PA may be managed even when a margin is set small, thus increasing the maximum communication distance.

In an mmWave wireless communication system, a communication distance must be guaranteed due to high wave attenuation. Consequently, a use of a technique for increasing a maximum communication distance like the SCW may be favorable to the BS. Generally, the SCW has a higher margin by about 5-6 dB than that of a multi-carrier waveform (MCW), such that an SCW transmitter uses a higher transmission power than for the MCW, increasing the communication distance. The SCW as shown in FIG. 1C is generally used for a UE having a lower limit for the maximum transmission power like an uplink, especially for uplink transmission of an LTE system. In particular, the UE has the low limit for the maximum transmission power, such that the magnitude of M may not be set large due to a shortage of an uplink transmission power. Moreover, the UE may guarantee the communication distance by reducing M as the transmission power is insufficient.

In the uplink, the BS receives a signal transmitted by one UE, and thus a case does not need to be considered where one or more UEs transmit a signal by using the same SC. On the other hand, in an mmWave wireless system, a shortage of power occurs in a downlink due to propagation attenuation, and simultaneous signal transmission of the BS for one or more UEs is required in downlink transmission needing support for such transmission.

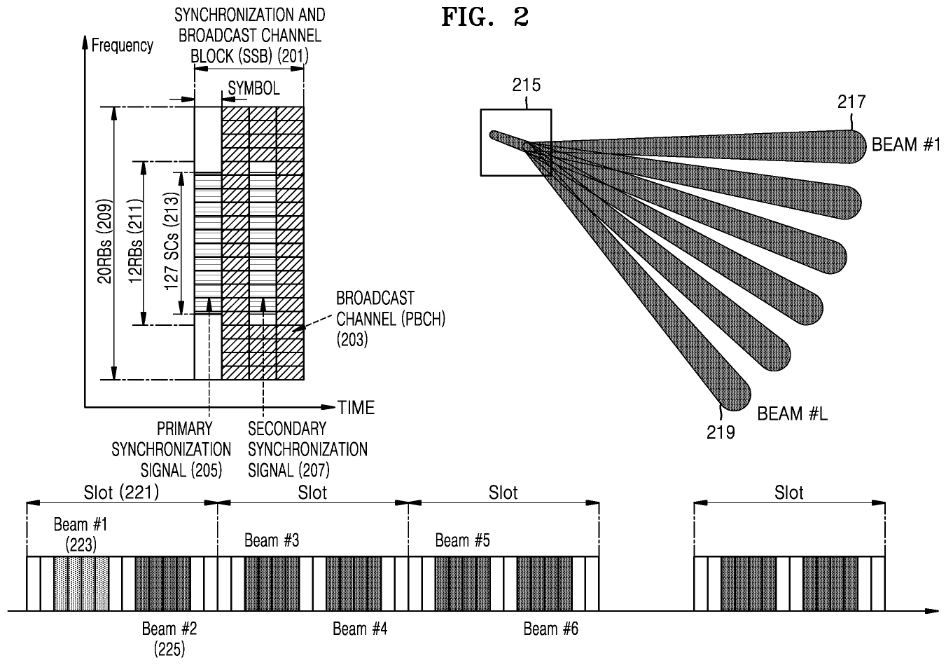

FIG. 2 is an illustration of a method of transmitting a downlink SS and a PBCH 203.

Referring to FIG. 2, the SS includes the PBCH 203, a primary SS (PSS) 205 and a secondary SS (SSS) 207. Herein, the SS and PBCH 203 may be collectively referred to as an SS and PBCH block (SSB) 201. Herein, a frequency band occupied by the PSS 205 and the SSS 207 has a size of 12 RBs 211, and an actually used length may occupy subcarriers having a length of 127 SCs 213. On the other hand, the PBCH 203 may occupy a total of 20 RBs 209. The PSS 205 has non-occupied parts at both sides of 127 subcarriers, whereas the SSS 207 is partially occupied by the PBCH 203 at both sides of the subcarriers. Power that is not used in the non-occupied parts may be used for power amplification of the PSS 205 and the SSS 207. A non-used region between the SSS 207 and the PBCH 203 may be intended for a marginal interval for application of a reception filter to the PSS 205 and the SSS 207. A feature of the SSB 201 in the NR system is using one or more beams 217 and 219 at one BS 215 to compensate for signal attenuation of propagation. Assuming that the BS 215 uses L beams, the BS 215 transmits L SSBs 201 as indicated by Beam #1 223 and Beam #2 225 in different time symbols in one cell, and an SSB 201 transmitted by one BS may use the same BS ID and may be transmitted using different unique SSB IDs. FIG. 2 shows a case where transmission is performed using a CP-OFDM (e.g., a first waveform).

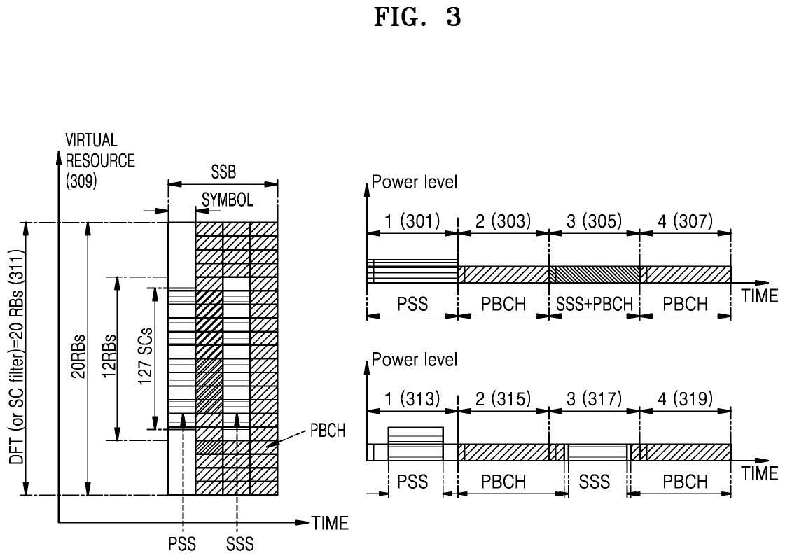

FIG. 3 is an illustration of a method of transmitting an SSB in millimeter waves, according to an embodiment.

Referring to FIG. 3, an SC waveform (e.g., a second waveform) may be generated using two preprocessing methods described below in greater detail: a preprocessing method using a DFT filter and a preprocessing method using oversampling. A scheme of the present disclosure applies a DFT filter of a size corresponding to a frequency bandwidth 311 in which an SSB is transmitted to all of the PSS, the SSS, and the PBCH. A scheme according to the related art uses a CP-OFDM scheme such that a difference between the scheme of the present disclosure and the scheme according to the related art may not be identified in a frequency axis or a virtual frequency axis, but, in terms of a time-axial sample, the difference may be recognized.

A scheme using the CP-OFDM may be based on a symbol architecture of symbols 301, 303, 305, and 307, and a scheme using DFT-s-OFDM may be based on a symbol architecture of symbols 313, 315, 317, and 319. In the scheme using the CP-OFDM, the PSS where symbol 301 is transmitted does not use a partial frequency region as in virtual resource 309, such that further power increase as in symbol 301 is possible and a coverage may be further improved for other symbols. On the other hand, in the scheme using DFT-s-OFDM, as in symbol 313, a filter corresponding to the frequency bandwidth 311 is applied and a waveform of a time symbol is a single carrier, allowing the PA to perform transmission using further power and, thus, improving a coverage by increasing power per symbol as in symbol 313.

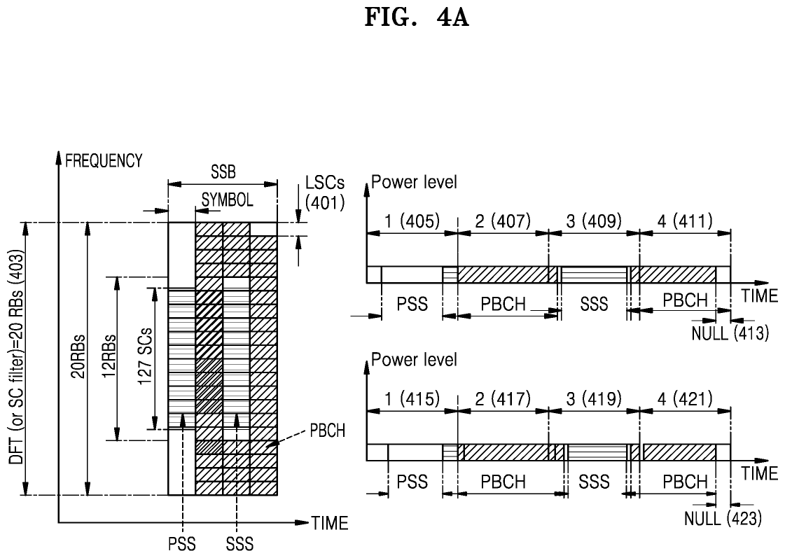

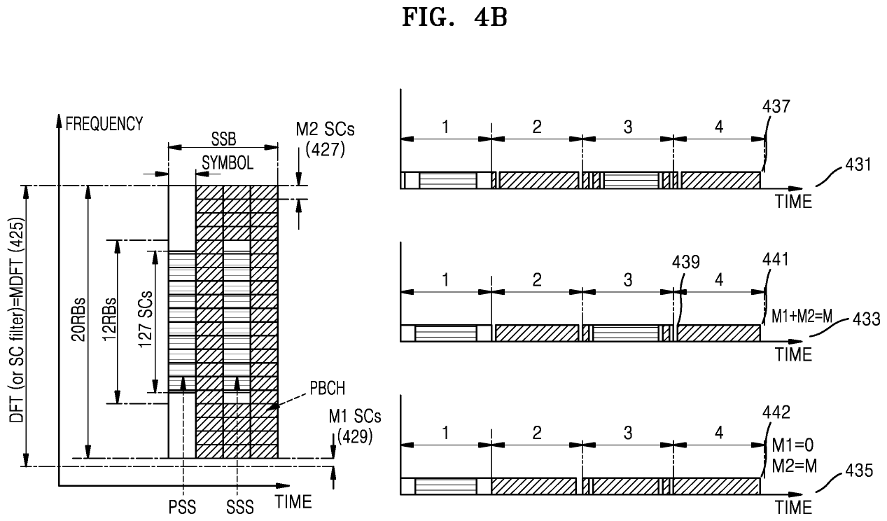

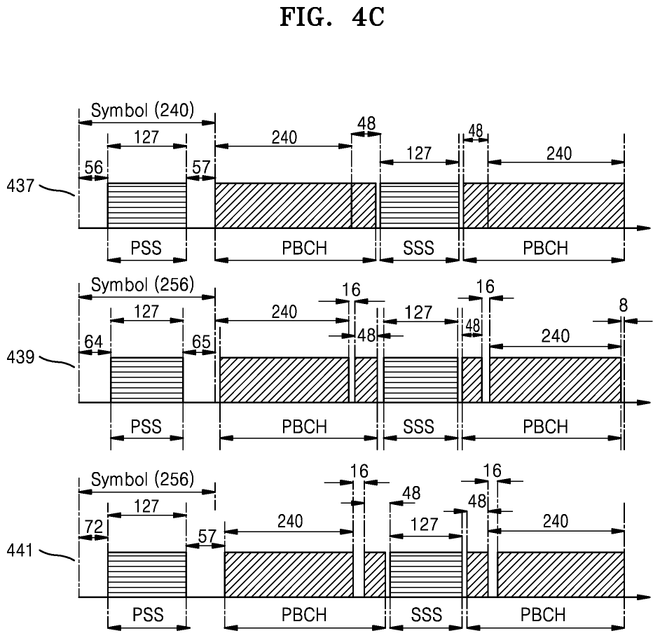

FIG. 4A is an illustration of a resource allocation method for reducing symbol interference, according to an embodiment.

Referring to FIG. 4A, in a second embodiment, for SSB transmission using a single carrier, DFT-s-OFDM preprocessing corresponding to a same size as a bandwidth 403 of a transmission channel may be performed. Herein, some resources of a last symbol among transmission symbols may be processed as null and transmitted. Processing as null may indicate that mapping of a data symbol does not occur, and L subcarriers (LSCs) 401 or PRB resources may not be used. The method may prevent inter-symbol interference of a data channel occurring after a symbol 411 when a CP is not used as in symbols 405, 407, 409, and 411. Even when a CP is transmitted together as in symbols 415, 417, 419, and 421, a corresponding effect may be equally applied, and, in this case, even when the BS sets the length of the CP very short, the CP may be used to prevent inter-symbol interference further occurring due to large channel diffusion.

FIG. 4B is an illustration of a method of configuring a single carrier band to reduce symbol interference, according to an embodiment.

Referring to FIG. 4B, a third embodiment of the disclosure includes a method of configuring the BS is configured to use preprocessing of a larger size than a size occupied by a maximum bandwidth 425 of an SSB. Thus, unlike in the second embodiment, in the third embodiment, a DFT precoder of a size corresponding to additional M1 subcarriers (M1 SCs) 429 and M2 subcarriers (M2 SCs) 427 may be used at both ends of an SSB bandwidth for SSB transmission. In this case, when a CP is ignored, as indicated by 433, on the time axis, in a start 439 and an end 441 of a symbol, there may be a sample where a signal is not transmitted, thus, preventing interference between a previous symbol and a next symbol. As indicated by 435, M1=0, such that the same result as in the second embodiment of the present disclosure described above may be shown. Moreover, when the BS transmits system information, the BS may identify the entire system information as first system information and second system information, configure M1 based on the first system information, and deliver the second system information to the PBCH. In this case, when the UE receives the SSB, the UE may attempt reception of the SSB by changing a magnitude of M1 while maintaining M. By using M1 for successful SSB transmission, the UE may obtain the first system information, obtain the second system information through the PBCH, and obtain the entire system information through the first system information and the second system information. Herein, in the presence of CP transmission, a symbol is transmitted as indicated by 431, and depending on a size of a CP, data transmission may not occur in an end 437 of a symbol.

FIG. 4C is an illustration of a method of configuring a single carrier band to reduce symbol interference, according to an embodiment.

Referring to FIG. 4C, a sample-based SSB transmission 437 for a DFT size of 240 and M1 and M2 are equal to 0 in the third embodiment is illustrated. A sample-based SSB transmission 439 for a DFT size of 256 and M1 and M2 are equal to 8 is also illustrated. A sample-based SSB transmission 441 for a DFT size of 256, M1 is equal to 16, and M2 is equal to 0 is also illustrated.

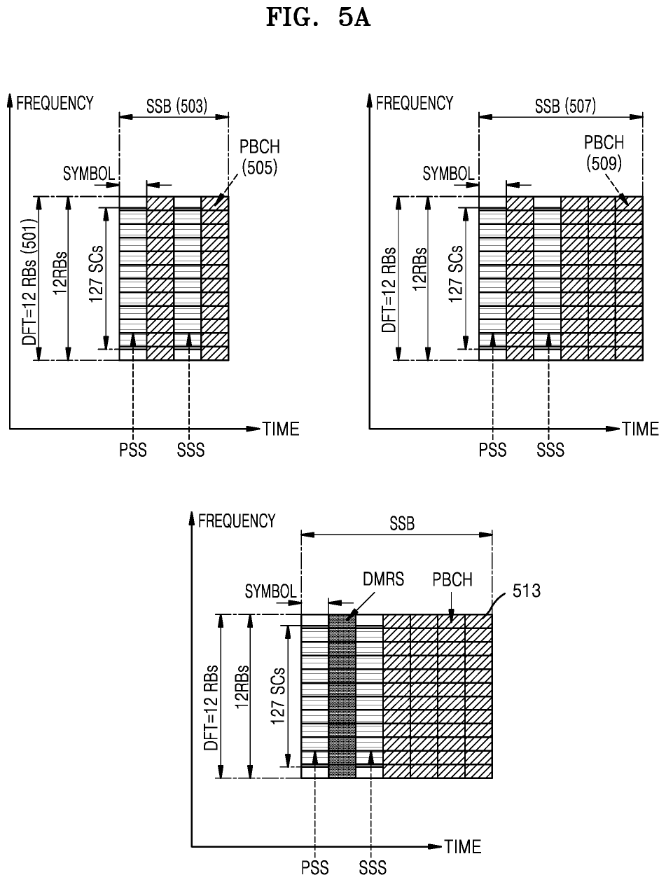

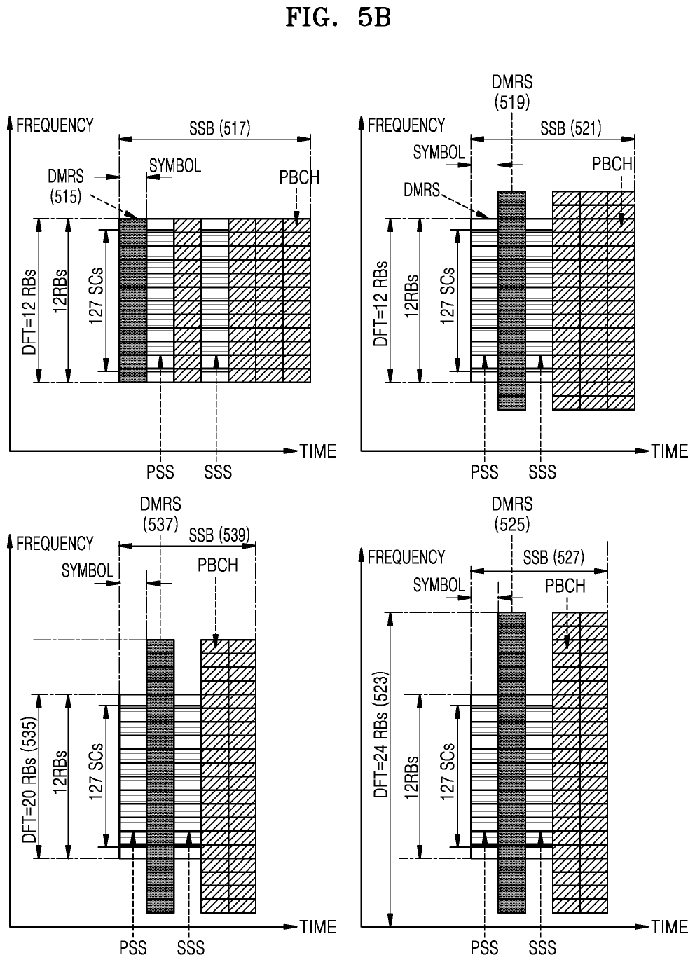

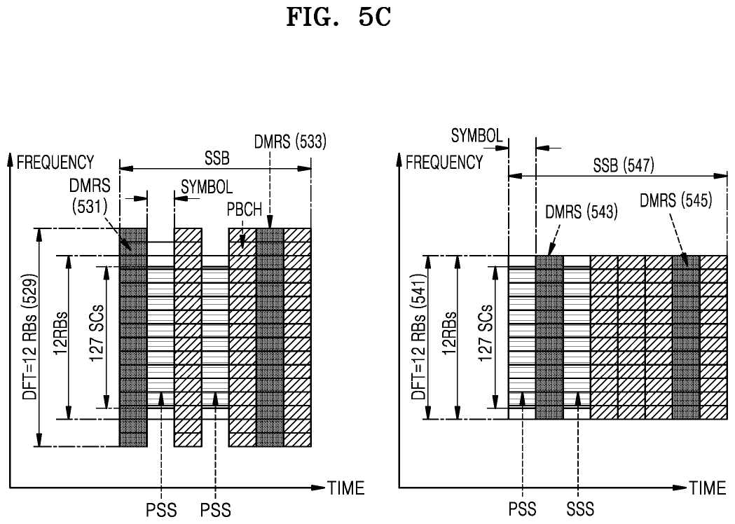

FIG. 5A is an illustration of a resource allocation method for SS and PBCH transmission, according to an embodiment.

Referring to FIG. 5A, a fourth embodiment includes a method of transmitting an SSB 503 in a narrow bandwidth 501 by using a single carrier to improve a coverage of the SSB 503 is shown. More specifically, in a first method, a size of a preprocessor of a single carrier transmitted in a PBCH is equal to a size of a PRB occupied by a PSS and an SSS and a DMRS is not transmitted in the PBCH. Due to an absence of an overhead of the DMRS, channel estimation for PBCH reception may be performed using channel information obtained from the PSS and the SSS. Herein, the PSS and the SSS may be included in an SC transmission, and, otherwise, an SC transmission may be included only in a PBCH transmission symbol 505.

In a second method, a size of a preprocessor of an SC transmitted in a PBCH is equal to a size of a PRB occupied by a PSS and an SSS, as indicated by SSB 507, and a DMRS is not transmitted in the PBCH and a transmission time of the PBCH is lengthened. In the second method, the use of the channel information obtained from the PSS and the SSS for channel estimation for PBCH reception due to absence of the overhead of the DMRS is the same as in the first method, but in the second method, the transmission time of the PBCH may be lengthened by one or more to extend the coverage of the PBCH. Herein, the PSS and the SSS may be included in SC transmission, and otherwise, SC transmission may be included only in a PBCH transmission symbol 509.

In a third method, the size of the preprocessor of the SC transmitted in the PBCH is equal to the size of the PRB occupied by the PSS and the SSS, and the DMRS is not transmitted in the PBCH, but a separate DMRS is transmitted between the PSS and the SSS. Channel estimation for PBCH reception uses channel information obtained through the PSS, the SSS, and the DMRS. Herein, the PSS and the SSS may be included in SC transmission, and otherwise, SC transmission may be included only in a PBCH transmission symbol 513. One or more symbols of the DMRS may be positioned anywhere in the SSB transmission symbol except for the PSS and the SSS. The symbol of the DMRS may not be positioned in the same symbol as the PBCH transmission symbol 513. However, this is merely an example, and the symbol position of the DMRS is not limited to the example.

FIG. 5B is an illustration of a resource allocation method for SS and PBCH transmission, according to an embodiment.

Referring to FIG. 5B, the third embodiment of the present disclosure may involve a method of reducing a length of an SSB symbol additionally consumed in narrow-bandwidth SSB transmission is shown. The method extends a transmission bandwidth of a PBCH symbol and a DMRS symbol used for PBCH transmission in a way to reduce the length of the SSB symbol. To maintain a transmission rate of the PBCH identical to an existing one, a total of four symbols are required, and in addition, a DMRS 515 may be transmitted in a symbol previous to the PSS.

However, in this case, a total of seven symbols may be consumed for SSB transmission, increasing an overhead due to the increase of symbols consumed. In this case, as indicated by an SSB 521, the number of symbols of the PBCH may be reduced by one and the number of PRBs consumed for the DMRS 519 and the PBCH may be set to 16 for transmission. In this case, a length of a DFT precoder may be set to 16*12. When one symbol is further reduced, transmission of the SSB 539 may be performed using a total of five symbols, and the number of PRBs used for the DMRS 537 and the PBCH may be 20 as indicated by bandwidth 535, in which the length of the DFT precoder may be 20*12. When transmission of the SSB 527 is performed using a total of four symbols as in a case according to the related art, 24 PRBs may be used for the DMRS 525 and the PBCH, in which the length of the DFT precoder may be 24*12. The present disclosure may include a feature in which the length of the DFT precoder used for the PSS and the SSS is different from the length of the precoder used for the PBCH and the DMRS, and may also include a method in which the DFT precoder is not used for transmission of the PSS and the SSS.

FIG. 5C is an illustration of a resource allocation method for SS and PBCH transmission, according to an embodiment.

Referring to FIG. 5C, a method of performing transmission using one or more DMRS symbols according to the third embodiment of the disclosure is shown. According to a first method, 16 PRBs may be occupied for transmission of the DMRS and the PBCH, and the length 529 of the DFT precoder may be 16*12. To obtain the channel information fast, a first DMRS 531 may be transmitted prior to the PSS and a second DMRS 533 may be transmitted between PBCH symbols.

According to a second method, a total of 8 symbols may be used for SSB 547 transmission, while using two DMRS symbols 543 and 545. According to the second method, 12 PRBs may be occupied for transmission of the DMRS and the PBCH, and a DFT precoding length 541 may be 12*12. To obtain the channel information fast, the first DMRS 543 may be transmitted between the PSS and the SSS and the second DMRS 545 may be transmitted between PBCH symbols.

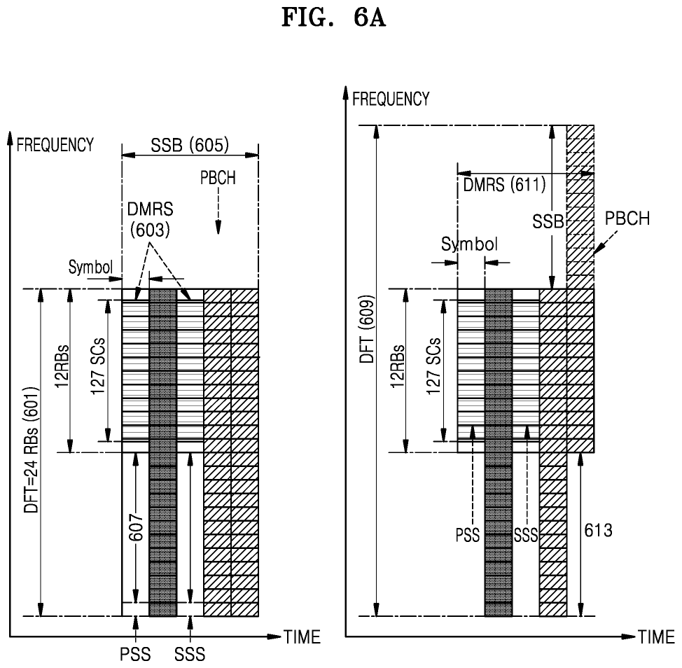

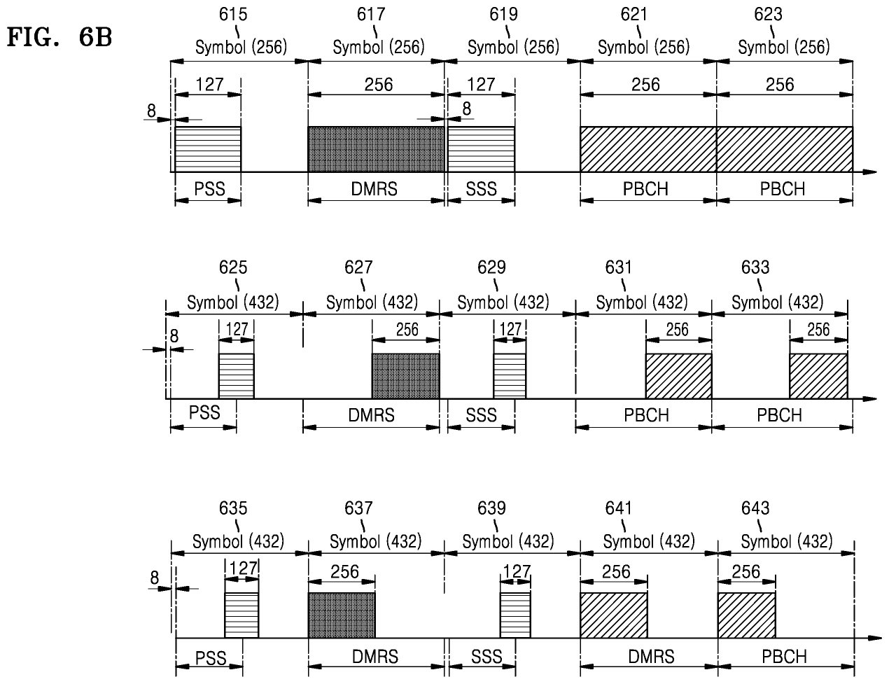

FIG. 6A is an illustration of a method of determining a bandwidth and a central frequency for SS and PBCH transmission, according to an embodiment of the present disclosure.

Referring to FIG. 6A, in a fourth embodiment, a length of a DFT precoder may be set greater than that of the PSS/SSS or the PBCH, and transmission may be performed by adjusting a position occupied by the PSS/SSS and the PBCH. More specifically, a first method includes fixing a transmission position of the PSS/SSS is fixed, the PBCH with a gap 607 from the PSS and the SSS of FIG. 6A is mapped, the length of the DFT precoder is configured to be identically to the length of the PBCH, and the DFT-s-OFDM preprocessor for transmission is applied.

Moreover, when a BS transmits system information, the BS may identify the entire system information as first system information and second system information, determine the gap 607 based on the first system information, and deliver the second system information to the PBCH. In this case, when the UE receives the SSB, the UE may attempt reception of the SSB by changing a magnitude of the gap 607 while maintaining M. When the UE succeeds in SSB transmission, the UE may obtain the first system information through the length of the gap 607, obtain the second system information through the PBCH, and obtain the entire system information through the first system information and the second system information. A second method includes fixing a transmission position of the PSS/SSS, mapping the PBCH with a gap from the PSS and the SSS as indicated by 613 and 617, configuring the length of the DFT precoder greater than the length of the PBCH, as indicated by 609, and applying the DFT-s-OFDM preprocessor for transmission. In this case, when the BS transmits system information, the BS may identify the entire system information as first system information and second system information, determine the DMRS 611 or SSS 613 based on the first system information, and deliver the second system information to the PBCH. In this case, when the UE receives the SSB, the UE may attempt reception of the SSB by changing a magnitude of the gap 607 while maintaining M. When the UE succeeds in SSB transmission, the UE may obtain the first system information through the length of the gap 607, obtain the second system information through the PBCH, and obtain the entire system information through the first system information and the second system information.

FIG. 6B is an illustration of a method of determining a bandwidth and a central frequency for SS and PBCH transmission, according to an embodiment.

Referring to FIG. 6B, symbols 615, 617, 619, 621, and 623 show sample-based transmission for transmission using the first method according to the fourth embodiment. Thus, by changing the gap 607, the position of the PSS and the SSS may be changed in symbol 615 and symbol 619, and by using such position information, the first system information may be obtained. Symbols 625, 627, 629, 631, and 633 show sample-based transmission for transmission using the second method according to the fourth embodiment. As symbol 613 increases, a PBCH transmission position moves back as indicated by symbol 627 and symbol 631, and as symbol 611 increases, a PBCH transmission position moves forward in symbol 637 and symbol 641 of FIG. 6B. However, as indicated by 625, 629, 635, and 641, the position of the PSS/SSS may not change in a symbol. Thus, the first system information may be obtained through the position of the PBCH based on the PSS/SSS.

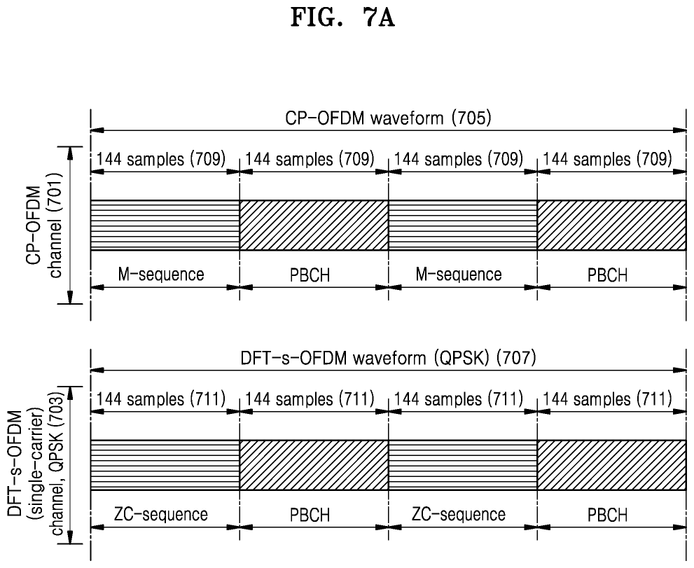

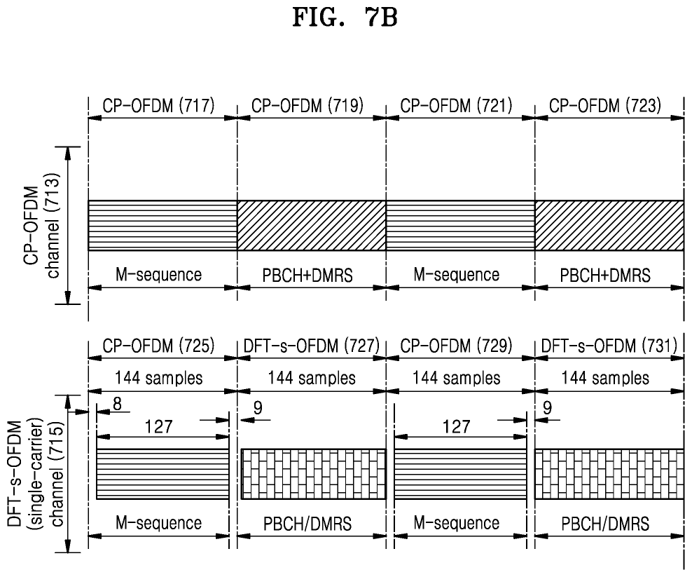

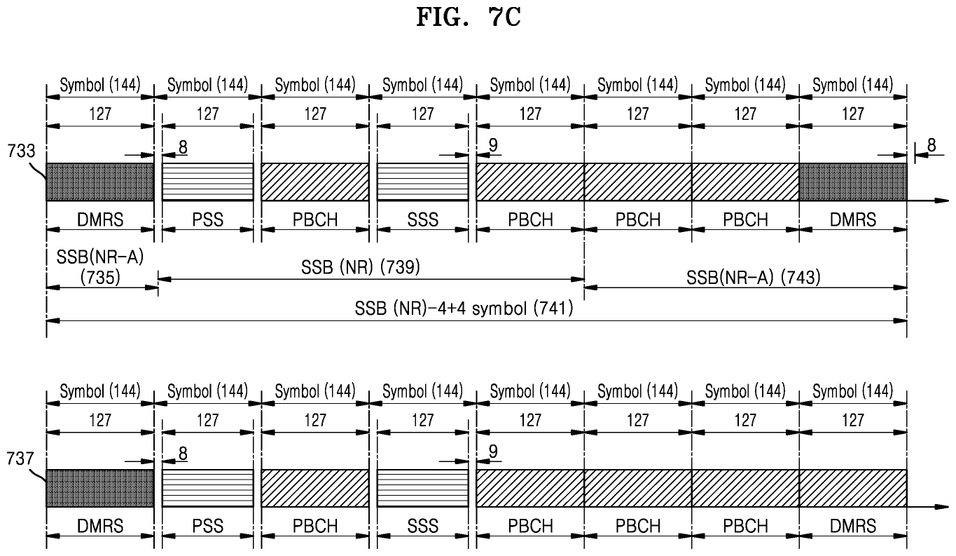

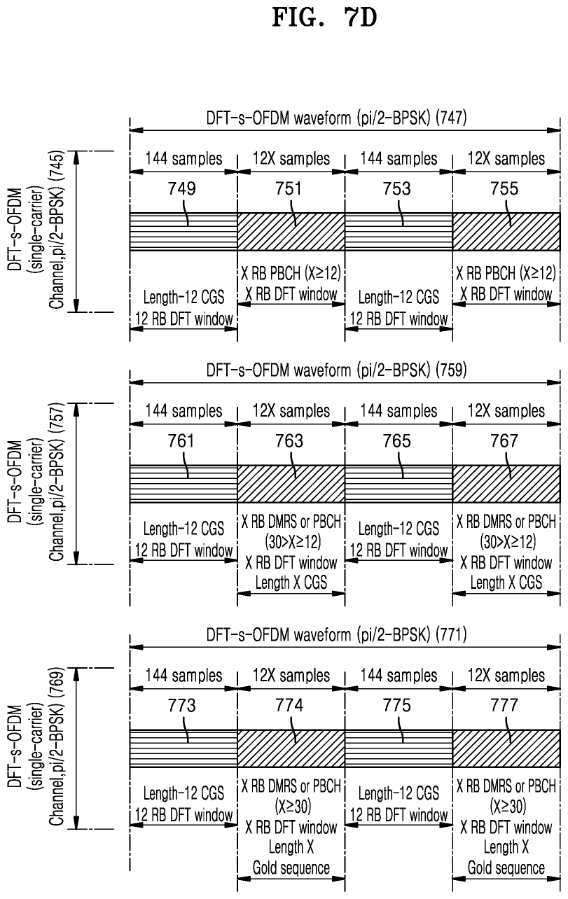

FIG. 7A is an illustration of a method of multiplexing an RS for PBCH, according to an embodiment.

Referring to FIG. 7A, according to a fifth embodiment, two formats are configured for SSB transmission, in which transmission is performed based on characteristics of each cell, beam, channel, and frequency band. Herein, a first format uses a first waveform and for PSS/SSS transmission, an m-sequence may be used. A second format uses a second waveform and for PSS/SSS transmission, a ZC-sequence may be used. In the fifth embodiment, the BS may transmit an SSB by selectively using the first format and the second format, and the UE may determine, from a success or failure in SSB reception, which one of the first waveform and the second waveform is used for a cell to secure a cell coverage for transmission.

FIG. 7B is an illustration of a method of multiplexing an RS for PBCH, according to an embodiment.

Referring to FIG. 7B, according to a sixth embodiment, two formats are configured for SSB transmission, in which transmission is performed based on characteristics of each cell, beam, channel, and frequency band. Herein, a first format uses a first waveform and for PSS/SSS transmission, an m-sequence may be used. In a second format, the PSS/SSS may be transmitted identically to the first waveform, and a second waveform may be used for PBCH transmission. Herein, the DMRS for the PBCH may be multiplexed identically to a PBCH data symbol prior to the DFT precoder. In the fifth embodiment, the BS may transmit an SSB by selectively using the first format and the second format, and the UE may determine, from a success or failure in PBCH reception after PSS/SSS search, which one of the first waveform and the second waveform is used for a cell to secure a cell coverage for transmission.

For initial demodulation of the PBCH, by using DMRS information passing through a DFT postprocessor using a channel obtained through the PSS/SSS, the PBCH may be iteratively recovered, thereby improving PBCH reception performance.

FIG. 7C is an illustration of a method of multiplexing an RS for PBCH, according to an embodiment.

Referring to FIG. 7C, in a seventh embodiment, two formats are configured for SSB transmission as indicated by 733, and the two formats are transmitted at the same time. Herein, in the first format, an existing SSB 739 may be transmitted using the first waveform, and the second format may be configured with the DMRS and PBCH symbols and transmitted using the second waveform, such that the second format is arranged before and after the first format as indicated by 735 and 743. A total of four symbols may be transmitted using the second waveform, and the embodiment of the disclosure may include transmission of the symbols using the continuous first waveform before, in the middle of, or after the second format, such that transmission may be performed using a total of eighth symbols 741. As indicated by 737, one or two DMRSs may be used.

FIG. 7D is an illustration of a method of multiplexing an RS for PBCH, according to an embodiment.

Referring to FIG. 7D, an eighth embodiment shows a second waveform-based SSB transmission format transmitted using a pi/2-binary phase shift keying (BPSK). In a first method, waveform 745 may not transmit the DMRS. The first method includes performing transmission by using a computer generated sequence (CGS) occupying 12 PRBs for transmission of a PSS 749 and an SSS 753, and a DFT precoding length is 12*12. In the first method, there is no DMRS in transmission of PBCHs 751 and 755, and the PBCH may be transmitted by occupying X PRBs that are more or equal to 12 PRBs, and the length of the DFT precoder may be 12*X.

In a second method, 757 corresponds to a case where the number of PRBs occupied by DMRS transmission is equal to or greater than 12 and less than or equal to 30. The second method includes performing transmission by using a CGS sequence occupying 12 PRBs for transmission of a PSS 761 and an SSS 765, and a DFT preprocessing length is 12*12. In the second method, the PBCH or DMRSs 763 and 767 may be transmitted in a symbol where the PSS/SSS is not transmitted. However, in the second method, when the number of occupied PRBs is equal to or greater than 12 and less than 30, the DMRS may be transmitted using a CGS sequence having a length of X, and the DMRS or the PBCH may be transmitted using the DFT precoder having a length of 12*X.

In a third method, 769 of FIG. 7D corresponds to a case where the number of PRBs occupied by DMRS transmission is greater than or equal to 30. The third method includes performing transmission by using a CGS sequence occupying 12 PRBs for transmission of a PSS 773 and an SSS 775, and a DFT precoding length is 12*12. In the third method, the PBCH or DMRSs 774 and 777 may be transmitted in a symbol where the PSS/SSS is not transmitted. According to the third method, when the number of occupied PRBs is greater than 30, the DMRS may be transmitted using a gold sequence corresponding to the number of occupied PRBs, X, and the DMRS or the PBCH may be transmitted using a DFT precoder having a length of 12*X.

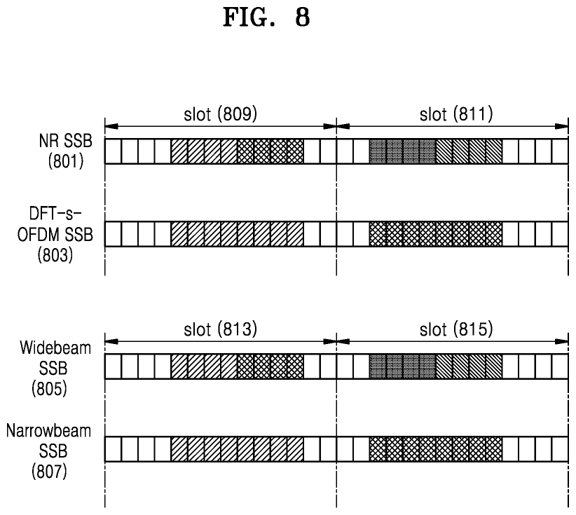

FIG. 8 is an illustration of a method of configuring SS and PBCH transmission symbols, according to an embodiment.

Referring to FIG. 8, in an eighth embodiment, the number of occupied SSB time symbols may differ with a type of a waveform transmitted and a beam width. When transmission is performed using the first waveform 801, transmission may be performed using four symbols, such that a total of four SSBs may be transmitted in two slots 809 and 811. When transmission is performed using the second waveform 803, transmission may be performed using eight symbols, such that a total of two SSBs may be transmitted in two slots. This method may be set based on a beam width used by the BS.

For transmission of a wide beam or transmission of the SSB to a narrow-coverage area 805, the BS may perform transmission using four symbols 813 and 815. For transmission of a narrow beam or transmission of the SSB to a broad-coverage area 807, the BS may perform transmission by setting a length of a transmission symbol to 8, thus extending the coverage. As used symbols increase, consumed power increases, such that in terms of reception, SSB reception performance may be improved. Moreover, one BS may transmit SSBs in different formats for each SSB in a cell, each channel in which the SSB is transmitted, or each band in which the SSB is transmitted. Therefore, the BS may perform transmission by using the first format 801 for the first symbol and by using the second format 803 for the second symbol. The BS may transmit the SSB using the first format or the first waveform for an area that is close to the BS or where channel reflection or diffusion is serious and using the second format or the second waveform for an area that is far from the BS or secures a line-of-sight from the BS or where channel reflection or diffusion is small, thereby guaranteeing a coverage in a cell.

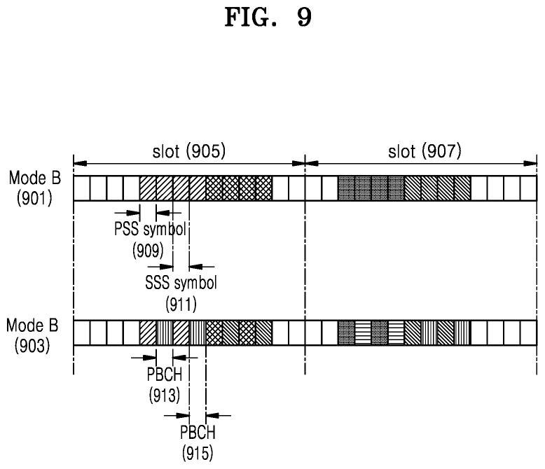

FIG. 9 illustrates a method of transmitting an SS and a PBCH using a first waveform and a second waveform, according to an embodiment. In the eighth embodiment, for transmission using a first waveform 901 and a second waveform 903, the BS may transmit a particular signal (e.g., a PSS 909 or an SSS 911) by using the first waveform 901 and may transmit other signals 913 and 915 by configuring different waveforms. In this case, the UE may attempt receive the PBCH using two different waveforms and obtain a waveform and information based on a demodulation-successful waveform.

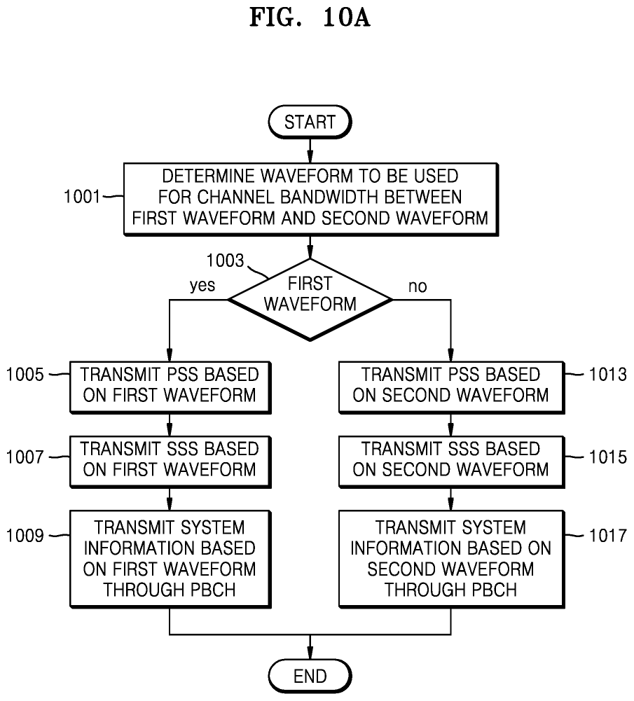

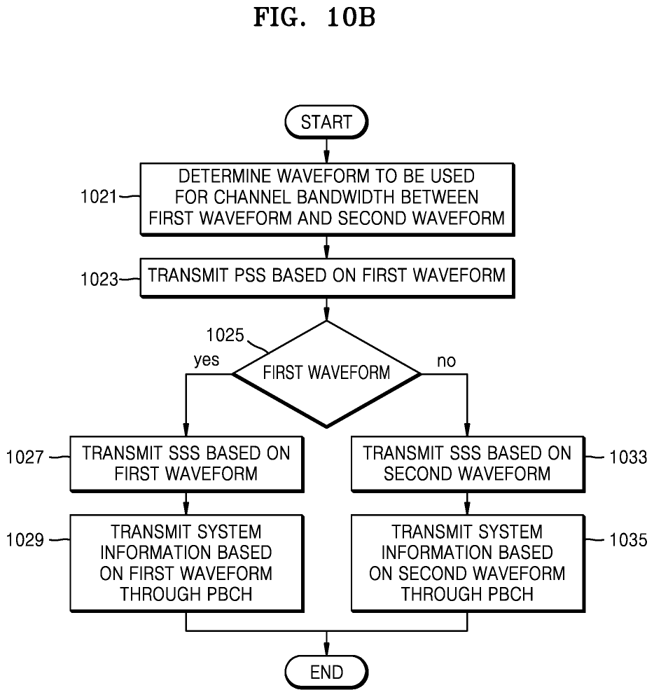

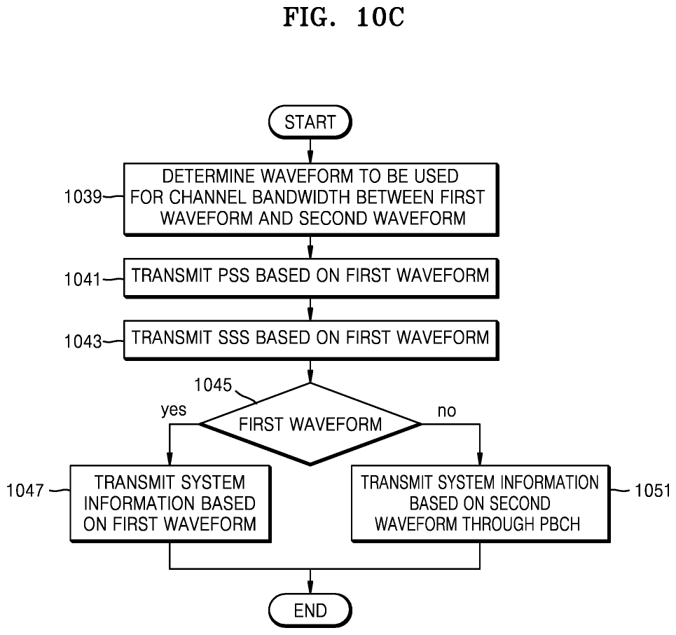

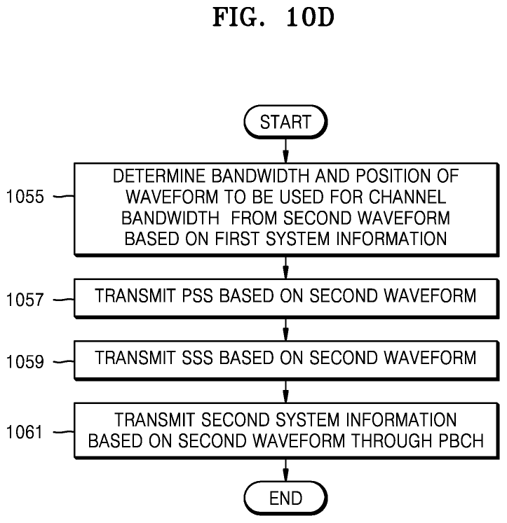

FIG. 10A is a flowchart of operations of a BS, according to an embodiment.

Referring to FIG. 10A, in step 1001, a BS may determine a waveform transmitted to an SSB and a corresponding bandwidth for each cell, each SSB, each beam, each frequency band, or each channel in a frequency band.

When a waveform configured for SSB transmission is a first waveform in step 1003, the BS may transmit a PSS based on the first waveform in step 1005, transmit an SSS based on the first waveform in step 1007, and transmit system information based on the first waveform through a PBCH in step 1009. For example, when a waveform configured for SSB transmission is a second waveform in step 1003, the BS may transmit a PSS based on the second waveform in step 1013, transmit an SSS based on the second waveform in step 1015, and transmit system information based on the second waveform through a PBCH in step 1017.

FIG. 10B is a flowchart of operations of a BS, according to an embodiment.

Referring to FIG. 10B, a BS may determine a waveform transmitted to an SSB and a corresponding bandwidth for each cell, each SSB, each beam, each frequency band, or each channel in a frequency band in step 1021, and transmit a PSS based on the first waveform in step 1023. When a waveform configured for SSB transmission is the first waveform in step 1025, the BS may transmit an SSS based on the first waveform in step 1027, and transmit system information based on the first waveform through a PBCH in step 1029. When the waveform configured for SSB transmission is the second waveform in step 1025, the BS may transmit an SSS based on the second waveform in step 1033, and transmit system information based on the second waveform through the PBCH in step 1035.

FIG. 10C is a flowchart of operations of a BS, according to an embodiment of the present disclosure.

Referring to FIG. 10C, in step 1039, a BS may determine a waveform transmitted to an SSB and a corresponding bandwidth for each cell, each SSB, each beam, each frequency band, or each channel in a frequency band. The BS may transmit the PSS based on the first waveform in step 1041, and transmit the SSS based on the second waveform in step 1043. When the waveform configured for SSB transmission is the first waveform in step 1045, the BS may transmit system information based on the first waveform through the PBCH in step 1047. When the waveform configured for SSB transmission is the second waveform in step 1045, the BS may transmit system information based on the second waveform through the PBCH in step 1051.

FIG. 10D is a flowchart of operations of a BS, according to an embodiment.

Referring to FIG. 10D, system information transmitted by the BS may be identified as the first system information and the second system information, and, in step 1055, the BS may determine a format of the second waveform, a resource mapping structure, or length and position of a DFT precoder, based on the first system information. The BS may transmit the PSS based on the second waveform in step 1057, and transmit the SSS based on the second waveform in step 1059. In step 1061, the BS may transmit the second system information based on the second waveform through the PBCH.

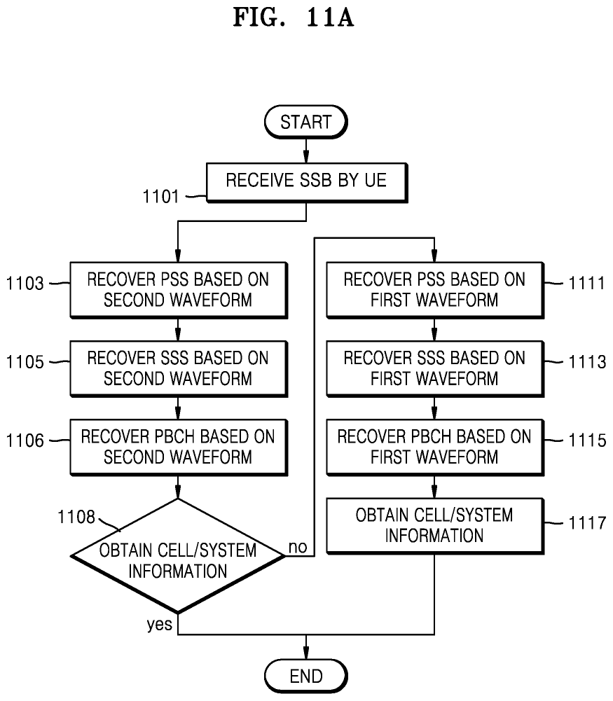

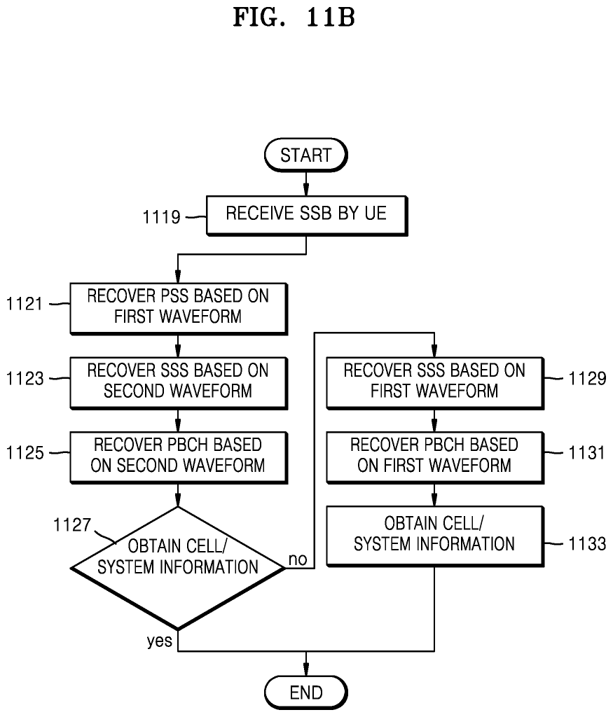

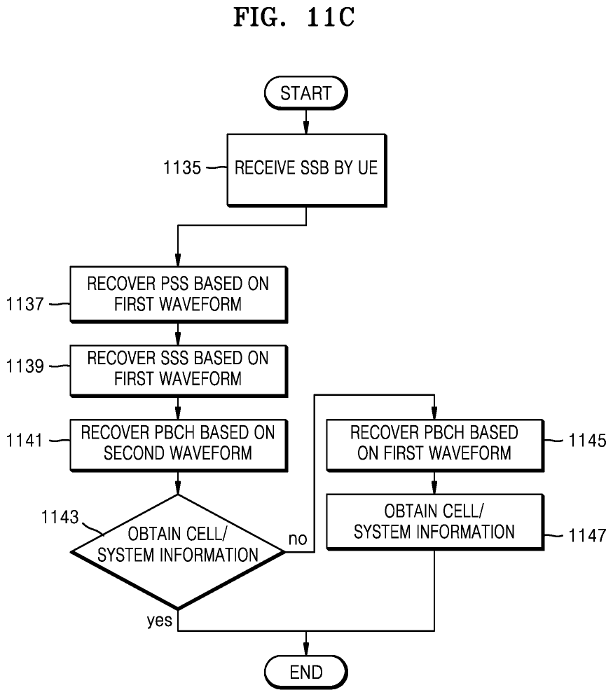

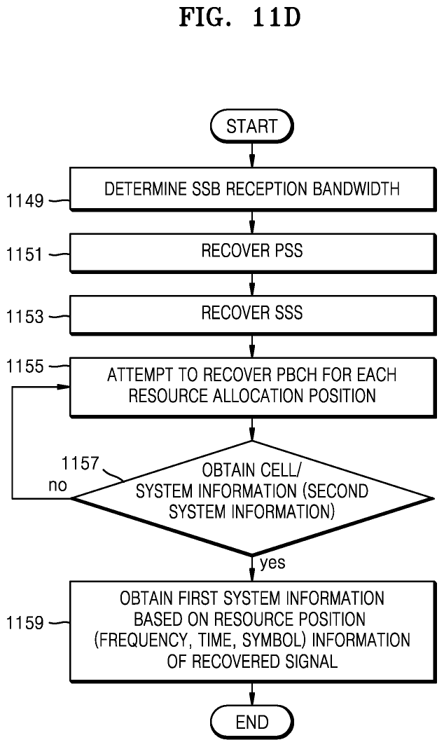

FIG. 11A is a flowchart of operations of a UE, according to an embodiment.

Referring to FIG. 11A, in step 1101, the UE may receive an SSB for each cell, each SSB, each beam, each frequency band, or each channel in a frequency band.

The UE may recover a PSS based on the second waveform in step 1103, recover an SSS based on the second waveform in step 1105, and recover a PBCH based on the second waveform in step 1106. When the UE obtains system information in step 1106, the UE may terminate SSB reception in step 1108. When the UE fails to obtain the system information in step 1106, the UE may recover the PSS based on the first waveform in step 1111, recover the SSS based on the first waveform in step 1113, recover the PBCH based on the first waveform in step 1115, and obtain the system information in step 1117. While steps 1103 through 1117 of recovering the PSS are sequentially described above, those steps may also be performed in order of step 1103, step 1111, step 1105, step 1113, step 1106, step 1115, step 1108, and step 1117.

FIG. 11B is a flowchart of operations of a UE, according to an embodiment.

Referring to FIG. 11B, in step 1119, the UE may receive an SSB for each cell, each SSB, each beam, each frequency band, or each channel in a frequency band. The UE may recover a PSS based on the first waveform in step 1121, recover an SSS based on the second waveform in step 1123, and recover a PBCH based on the second waveform in step 1125. When the UE obtains system information in step 1127, the UE may terminate SSB reception. When the UE fails to obtain the system information in step 1127, the UE may recover the SSS based on the first waveform in step 1129, recover the PBCH based on the first waveform in step 1131, and obtain the system information in step 1133. While steps 1123 through 1133 of recovering the SSS are sequentially described above, those steps may also be performed in order of step 1123, step 1129, step 1125, step 1131, step 1127, and step 1133.

FIG. 11C is a flowchart of operations of a UE, according to an embodiment.

Referring to FIG. 11C, in step 1135, the UE may receive an SSB for each cell, each SSB, each beam, each frequency band, or each channel in a frequency band. The UE may recover a PSS based on the first waveform in step 1137, recover an SSS based on the first waveform in step 1139, and recover a PBCH based on the second waveform in step 1141. When the UE obtains system information in step 1143, the UE may terminate SSB reception. When the UE fails to obtain the system information in step 1143, the UE may recover the PBCH based on the first waveform in step 1145, and obtain the system information in step 1147. While steps 1141 through 1147 of recovering the PBCH are sequentially described above, those steps may also be performed in order of step 1141, step 1145, step 1143, and step 1147.

FIG. 11D is a flowchart of operations of a UE, according to an embodiment.

Referring to FIG. 11D, in step 1149, the UE may determine an SSB reception bandwidth for each cell, each SSB, each beam, each frequency band, or each channel in a frequency band. Thereafter, the UE may recover the PSS based on the second waveform in step 1151, and recover the SSS in step 1153. In step 1155, the UE may attempt to recover a PBCH based on a resource allocation position. When failing to obtain the second system information in step 1157, the UE may return to step 1155 to recover the PBCH based on another resource allocation position. When succeeding in obtaining the second system information in step 1157, the UE may obtain the first system information through resource position information obtained in 1159 and obtain the entire system information through the second system information secured in step 1157.

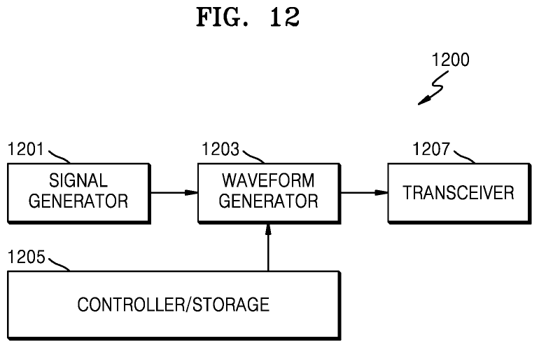

FIG. 12 is a block diagram of a BS 1200, according to an embodiment.

Referring to FIG. 12, the BS 1200 may include a transceiver 1207, a signal generator 1201, a waveform generator 1203, and a controller/storage 1205, in which the transceiver 1207 may transmit and receive a signal with a UE. Herein, the transmitted and received signal may include an SSB, control information and a reference signal, and data. To this end, the transceiver 1207 may include an RF transmitter that up-converts and amplifies a frequency of a transmission signal and an RF signal that low-noise-amplifies a received signal and down-converts a frequency. The transceiver 1207 may output a signal generated by the signal generator 1201 through the controller/storage 1205, and transmit the output signal through the transceiver 1207 in a radio channel. The controller/storage 1205 may control a series of processes to configure the first waveform and the second waveform and to enable the BS to operate according to an embodiment of the disclosure, and the signal generator 1201 may generate and multiplex signals in the first waveform and the second waveform.

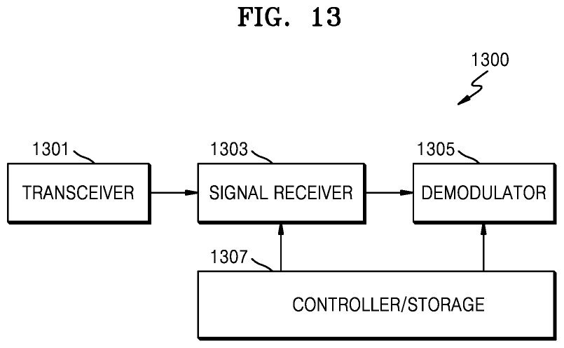

FIG. 13 is a block diagram of a UE 1300, according to an embodiment.

Referring to FIG. 13, the UE 1300 may include a transceiver 1301, a signal receiver 1303, a demodulator 1305, and a controller/storage 1307. The transceiver 1301 may transmit and receive a signal to and from a BS. Herein, the transmitted and received signal may include an SSB, control information and a reference signal, and data. To this end, the transceiver 1207 may include an RF transmitter that up-converts and amplifies a frequency of a transmission signal and an RF signal that low-noise-amplifies a received signal and down-converts a frequency. The transceiver 1301 may receive a signal through a radio channel and output the received signal to the signal receiver 1303, and recover the signal received from the controller/storage 1307 through the demodulator 1305. The controller/storage 1307 may control a series of processes to allow the UE to operate according to the above-described embodiment of the present disclosure.

According to an embodiment, the BS may improve an SS and a coverage of a channel by using an SC or a combination of an SC and an MCW in mmWaves.

While the present disclosure has been shown and described with reference to certain embodiments thereof, it will be understood by those skilled in the art that various changes in form and details may be made therein without departing from the spirit and scope of the present disclosure as defined by the appended claims and their equivalents.

What is claimed is:

1. A method, performed by a user equipment, of transmitting and receiving a synchronization signal in a wireless communication system, the method comprising:
receiving a synchronization signal block (SSB) from a base station;
recovering synchronization signals from the SSB, based on at least one waveform candidates for the SSB; and
obtaining system information based on the recovered synchronization signals.

2. The method of claim 1, further comprising, in a case that obtaining the system information based on a first waveform fails, recovering at least one of the synchronization signals based on a second waveform.

3. The method of claim 1, wherein modulation and a sequence used for the SSB are different for each of the at least one waveform candidates for the SSB.

4. The method of claim 1, further comprising, in a case that obtaining the system information at a first reception bandwidth fails, recovering at least one of the synchronization signals at a second reception bandwidth, and
wherein a reception bandwidth of the SSB is determined for each cell, beam, frequency band or channel in a frequency band.

5. The method of claim 1, wherein the synchronization signals include a primary synchronization signal (PSS), a secondary synchronization signal (SSS) and a physical broadcast channel (PBCH), and further comprising:
transmitting a demodulation reference signal (DMRS) separately from the PBCH, and
estimating a channel for reception of the PBCH based on channel information obtained from the PSS and the SSS.

6. A method, performed by a base station, of transmitting and receiving a synchronization signal in a wireless communication system, the method comprising:
determining at least one waveform candidates for a synchronization signal block (SSB); and
transmitting the SSB based on the determined at least one waveform candidates,
wherein system information is obtained by a user equipment based on synchronization signals recovered from the SSB.

7. The method of claim 6, further comprising, in a case that obtaining the system information based on a first waveform fails, recovering at least one of the synchronization signals based on a second waveform.

8. The method of claim 6, further comprising determining modulation and a sequence for each of the at least one waveform candidates for the SSB.

9. The method of claim 6, further comprising, in a case that obtaining the system information at a first reception bandwidth fails, recovering at least one of the synchronization signals at a second reception bandwidth, and
determining a reception bandwidth of the SSB for each cell, beam, frequency band or channel in a frequency band.

10. The method of claim 6, wherein the synchronization signals include a primary synchronization signal (PSS), a secondary synchronization signal (SSS) and a physical broadcast channel (PBCH), and further comprising:
transmitting a demodulation reference signal (DMRS) separately from the PBCH, and
estimating a channel for a PBCH reception based on channel information obtained from the PSS and the SSS.

11. A user equipment (UE) for transmitting and receiving a synchronization signal in a wireless communication system, the UE comprising:
a transceiver; and
at least one processor coupled with the transceiver and configured to:
control the transceiver to receive a synchronization signal block (SSB) from a base station,
recover synchronization signals from the SSB, based on at least one waveform candidates for the SSB, and
obtain system information based on the recovered synchronization signals.

12. The UE of claim 11, wherein the at least one processor is further configured to, in a case that obtaining the system information based on a first waveform fails, recover at least one of the synchronization signals based on a second waveform.

13. The UE of claim 11, wherein modulation and a sequence used for the SSB are different for each of the at least one waveform candidates for the SSB.

14. The UE of claim 11, wherein the at least one processor is further configured to, in a case that obtaining the system information at a first reception bandwidth fails, recover at least one of the synchronization signals at a second reception bandwidth, and
determine a reception bandwidth of the SSB for each cell, beam, frequency band or channel in a frequency band.

15. The UE of claim 11, wherein the synchronization signals include a primary synchronization signal (PSS), a secondary synchronization signal (SSS) and a physical broadcast channel (PBCH), and wherein the at least one processor is further configured to:
control the transceiver to transmit a demodulation reference signal (DMRS) separately from the PBCH, and
estimate a channel estimation for a PBCH reception based on channel information obtained from the PSS and the SSS.

16. A base station (BS) for transmitting and receiving a synchronization signal in a wireless communication system, the BS comprising:
a transceiver; and
at least one processor coupled with the transceiver and configured to:
determine at least one waveform candidates for a synchronization signal block (SSB), and
control the transceiver to transmit the SSB based on the determined at least one waveform candidates,
wherein system information is obtained by a user equipment based on synchronization signals recovered from the SSB.

17. The BS of claim 16, wherein the at least one processor is further configured to, in a case that obtaining the system information based on a first waveform fails, recover at least one of the synchronization signals based on a second waveform.

18. The BS of claim 16, wherein the at least one processor is further configured to determine modulation and a sequence for each of the at least one waveform candidates for the SSB.

19. The BS of claim 16, the at least one processor is further configured to, wherein in a case that obtaining the system information at a first reception bandwidth fails, recover at least one of the synchronization signals at a second reception bandwidth, and
determine a reception bandwidth of the SSB for each cell, beam, frequency band or channel in a frequency band.

20. The BS of claim 16, wherein the synchronization signals include a primary synchronization signal (PSS), a secondary synchronization signal (SSS) and a physical broadcast channel (PBCH), and wherein the at least one processor is further configured to:
control the transceiver to transmit a demodulation reference signal (DMRS) separately from the PBCH, and
estimate a channel estimation for a PBCH reception based on channel information obtained from the PSS and the SSS.
